(19) United States
(12) Patent Application Publication
(10) Pub. No.: US 2026/0285306 A1
(43) Pub. Date: Sep. 24, 2026

(54) Assistance System for Supporting a Driver of a Vehicle When Forming an Emergency Lane, Taking Into Account Other Road Users, Vehicle and Method

(71) Applicant: Bayerische Motoren Werke Aktiengesellschaft, Muenchen (DE)

(72) Inventor: Christoph RESCH, Muenchen (DE)

(21) Appl. No.: 19/477,540

(22) PCT Filed: May 14, 2024
(86) PCT No.: PCT/EP2024/063254

§ 371 Date: Oct. 22, 2025

(30) Foreign Application Priority Data
May 25, 2023 (DE) 10 2023 113 833.2

(51) Int. Cl. B60W 30/12; B60W 10/20; B60W 60/00

(52) U.S. Cl. CPC B60W 30/12; B60W 10/20; B60W 60/0015; B60W 2520/10; B60W 2552/53; B60W 2554/4041; B60W 2554/4042; B60W 2554/801

(57) ABSTRACT

An assistance system for supporting a driver of a vehicle when forming an emergency lane is disclosed. The assistance system determines whether a predetermined emergency lane situation exists, in which an emergency lane is to be formed by the vehicle, determines a lane edge to which the vehicle is to be moved in order to form the emergency lane, carries out automated lateral guidance of the vehicle to the lane edge, if the predetermined emergency lane situation exists, using the environment data to determine a differential speed between the vehicle and at least one of the other road users on an adjacent lane, using the environment data to determine a lateral distance of the at least one of the other road users from a lane marking of the adjacent lane, and performs the automated lateral guidance according to the differential speed and/or the lateral distance.

### BACKGROUND AND SUMMARY

The present invention relates to an assistance system for supporting a driver of a vehicle when forming an emergency lane. In addition, the present invention relates to a vehicle having such an assistance system. Furthermore, the present invention relates to a method for supporting a driver of a vehicle when forming an emergency lane.

Lane keeping assistants for vehicles are sufficiently known from the prior art. Such lane keeping assistants, which are also referred to as steering and lane keeping assistants or also as active lane keeping assistants, are used to keep the vehicle within the lane or an ego lane. Such a lane keeping assistant uses the surroundings data from at least one surroundings sensor of the vehicle in order to recognize the boundaries of the lane or the roadway markings. Automated steering interventions can be carried out by means of the lane keeping assistant in order to keep the vehicle within the lane.

In addition, so-called emergency lane assistants are known from the prior art, which support a driver of the vehicle when forming an emergency lane. Such assistance systems recognize in an automated manner whether an emergency lane is to be formed or not. It is checked using these emergency lane assistants whether a defined emergency lane situation exists. For this purpose, it is evaluated whether the vehicle is in a country in which an emergency lane is to be formed. Furthermore, it is checked whether a congestion situation exists and whether the vehicle is located on a relevant road type, for example, a freeway or the like. In addition, it is ascertained on which lane the vehicle is currently located in order to know in which direction the emergency lane is to be formed. It is determined in this case whether the vehicle is to be moved to the right or the left lane edge of the lane to form the emergency lane.

If the above-described requirements are met and the vehicle falls below a specific speed threshold, with active lateral control system, an emergency lane is automatically formed in the correct direction. For this purpose, the vehicle drives to the previously determined lane edge or the previously determined roadway marking. The advantage is that the driver therefore does not have to deactivate the lateral control system or the lane keeping assistant in order to form an emergency lane in the congestion. It is made possible for the driver to continue to drive in the congestion with emergency lane while still being laterally controlled. A significant increase in comfort during laterally controlled journeys in congestion situations results in this way.

It is the object of the present invention to disclose a solution for how the functions of assistance systems for supporting a driver when forming an emergency lane can be improved.

This object is achieved according to the invention by an assistance system, by a vehicle, and by a method having the features according to the independent claims. Advantageous refinements of the present invention are specified in the dependent claims.

An assistance system according to the invention is used to support a driver of a vehicle when forming an emergency lane. The assistance system is configured to receive surroundings data, wherein the surroundings data describe lanes of a roadway and wherein the surroundings data describe a position and a speed of further road users on the roadway. In addition, the assistance system is configured to determine whether a predetermined emergency lane situation exists, in which an emergency lane is to be formed by the vehicle. In addition, the assistance system is configured to determine a lane edge, to which the vehicle is to be moved to form the emergency lane. Furthermore, the assistance system is configured to carry out an automated lateral control of the vehicle to the determined lane edge if the predetermined emergency lane situation exists. Furthermore, the assistance system is configured to determine a differential speed between the vehicle and at least one of the further road users on an adjacent lane on the basis of the surroundings data, and to determine a lateral distance of the at least one of the further road users to a roadway marking of the adjacent lane on the basis of the surroundings data. In addition, the assistance system is configured to carry out the automated lateral control depending on the differential speed and/or the lateral distance.

The driver of the vehicle is to be supported when forming the emergency lane with the aid of the assistance system. Such an emergency lane can also be referred to as a “free lane”. It is provided that by means of the assistance system, the functionality of a lane keeping assistant or the functionality of an automated lane keeping function is provided. In this case, the driver of the vehicle can be assisted in steering tasks. In particular, it is possible to intervene in the steering by means of the assistance system such that the vehicle is kept within the lane or the current lane.

The assistance system can have a computing unit, which can be formed by at least one processor, by at least one electronic control unit, or the like. The surroundings data can be received from at least one surroundings sensor of the assistance system with the aid of the computing unit of the assistance system. These surroundings data can describe the environment of the vehicle or the surroundings of the vehicle. The surroundings sensor can be, for example, a camera. In this case, the surroundings data can be image data. The respective lanes of the roadway on which the vehicle is currently located can be recognized in these surroundings data. Preferably, lane boundaries of the respective lanes can be recognized for this purpose on the basis of the surroundings data. The lane boundaries can be roadway markings, for example, solid or dashed or interrupted lines. The lane boundaries can also be structural boundaries, for example, a wall, a guide rail, a curb, or the like. Furthermore, a median strip, a gravel bed, or the like can be detected as a lane boundary.

Moreover, the further road users on the roadway can be detected on the basis of the surroundings data. The respective relative location between the vehicle and the further road users can be ascertained on the basis of the surroundings data. Moreover, it is provided that a differential speed or a relative speed between the ego vehicle and the respective further road users in the surroundings of the vehicle is ascertained. Such surroundings data can be ascertained, for example, using a radar sensor, a lidar sensor, or the like. A speed signal, which describes the current speed of the ego vehicle, can also be used to determine the differential speed.

Moreover, it can be checked by means of the assistance system whether the predetermined emergency lane situation exists. This emergency lane situation exists, for example, if the vehicle is in a congestion situation or the current speed of the vehicle falls below a speed limiting value. Moreover, the emergency lane situation can exist if the vehicle is located on a predetermined road type, for example, a freeway or on a trunk road having at least two lanes for one direction. Such trunk roads can be, for example, highways, main roads, or the like.

If such an emergency lane situation exists, the emergency lane is to be formed using the vehicle in order to meet the legal requirements. In this case, the lane edge of the lane can be determined by means of the assistance system to which the vehicle is to be moved to form the emergency lane. If the vehicle is located on the left lane of a two-lane road, the vehicle is to be steered to the left lane edge to form the emergency lane. However, if the vehicle is located on the right lane, it is to be steered to the right lane edge of this lane. It is provided in this case that the vehicle is kept within the lane or is maneuvered to the respective edge of the lane when forming the emergency lane. The above-described regulation for the formation of the emergency lane applies, for example, in Germany. The country-specific regulations for the country in which the vehicle is currently located can be used for the formation of the emergency lane.

The surroundings data can be used to ascertain the lane on which the vehicle is currently located. On the basis of the surroundings data, the individual lanes in the surroundings of the vehicle can be detected. Moreover, corresponding roadway markings of the lanes can be detected. Furthermore, structural boundaries or the like can be detected in order to ascertain the current lane on which the vehicle is located. Alternatively or additionally, digital map data and in particular high-resolution digital map data can be used, which describe the respective lanes. The lane on which the vehicle is located can then be ascertained using a satellite-based localization or a lane positioning.

According to the present invention, it is now provided that the differential speed or a relative speed between the vehicle and at least one of the further road users on an adjacent lane is taken into account in the automated formation of the emergency lane. According to the present invention, at least one further road user is observed who is located on the adjacent lane. The adjacent lane can be arranged on the left or right next to the lane on which the vehicle is currently located.

Moreover, it is provided that on the basis of the surroundings data, the lateral distance of the at least one further road user on the adjacent lane to a roadway marking of the adjacent lane is determined. The lateral distance describes here in particular the distance of the further road user to one of the lane boundaries or roadway markings in the lateral direction of the further road user. In addition to the differential speed, the lateral location of the further road user in relation to the adjacent lane can thus be ascertained. This means that it can be checked whether the further road user is located centrally in the adjacent lane or at an edge of the adjacent lane. According to the present invention, it is now provided that the automated lateral control of the vehicle to form the emergency lane is carried out depending on the differential speed and/or the lateral distance.

In addition, it is taken into consideration according to the invention that during the formation of the emergency lane, which is carried out in an automated manner by means of the assistance system, a driving feeling subjectively perceived as uncomfortable and/or unsafe by the driver can arise. This depends in particular on the further road users who are located on the adjacent lane. On the one hand, the driving feeling perceived by the driver can depend on the differential speed between the ego vehicle and the further road user on the adjacent lane. Alternatively or additionally, the perceived driving feeling can depend on the position of the further road user in relation to the adjacent lane. According to the present invention, during the formation of the emergency lane or during the automated lateral control to form the emergency lane, the differential speed and/or the lateral distance of the at least one further road user in relation to the adjacent lane are taken into account. In particular, it is therefore possible to prevent an uncomfortable or unsafe driving feeling from arising for the driver. Overall, the functionality of the assistance system in the formation of the emergency lane can therefore be improved.

The at least one of the further road users is preferably located on the adjacent roadway lane which adjoins the lane edge to which the vehicle is to be moved to form the emergency lane. In other words, those road users are thus to be monitored which are located on the side of the vehicle to which the vehicle is to be maneuvered to form the emergency lane. If the ego vehicle is thus to be moved to the right lane edge to form the emergency lane, for example, the further road users are also to be monitored on the lane on the right next to the vehicle with respect to the differential speed and/or the lateral distance in relation to their lane.

In particular in cases in which the emergency lane is to be formed in the direction of an adjacent lane, in which the further road users are also located, the formation of the emergency lane can be subjectively perceived as uncomfortable and/or unsafe by the driver. For example, the driver can fear a possible collision with the further road users. In order to counter this problem, the automated lateral control of the vehicle in the direction of these further road users or in the direction of the adjacent lane can then be adapted depending on the road users who are located on this lane. A more unsafe and/or uncomfortable driving feeling in the driver of the vehicle can thus be avoided.

According to one embodiment, the automated lateral control to the determined lane edge does not take place if the differential speed exceeds a predetermined differential speed limiting value and/or if the lateral distance falls below a predetermined distance limiting value. For example, an unsafe and/or uncomfortable driving feeling can result for the driver if the further road users on the adjacent lane drive at a significantly lower speed than the ego vehicle. This driving feeling can moreover also be strengthened if the further road users are located close to the determined lane edge to which the vehicle moves to form the emergency lane. It can therefore be provided that the emergency lane is only formed in the direction of the adjacent lane having the further road users if the differential speed of the ego vehicle is low in comparison to the speed of the further road users. Alternatively or additionally, the emergency lane can be formed only if the vehicles on the adjacent lane have a corresponding lateral distance or lateral offset to the determined lane edge.

The differential speed limiting value and/or the distance limiting value can be permanently specified. It can also be provided that a defined vehicle speed is specified from which the emergency lane is formed at all. However, it can also be provided that the differential speed limiting value and/or the distance limiting value are selected depending on the speed of the ego vehicle. This can mean, for example, that for different speeds of the ego vehicle or different speed ranges of the ego vehicle, corresponding differential speed limiting values and/or distance limiting values are then specified.

In a further embodiment, the assistance system is configured to carry out the lateral control such that a lateral offset of the vehicle to the determined lane edge is determined depending on the differential speed and/or depending on the lateral distance. It can thus be checked how close the ego vehicle is moved to the determined lane edge or in the direction of the adjacent lane when forming the emergency lane. The lateral offset can describe the spacing or the distance of the vehicle to the lane edge to which the vehicle is to be moved to form the emergency lane in the vehicle lateral direction.

At a high differential speed between the ego vehicle and the at least one further road user on the adjacent lane, for example, a small lateral offset to the lane edge can be selected. This applies in the same manner when the at least one further road user is located relatively close to the roadway marking which is opposite to the lane of the ego vehicle. With a high differential speed and/or with a low lateral distance to the further road user, a comparatively small lateral offset can be selected when forming the emergency lane. This lateral offset can be progressively adapted to the differential speed and/or the lateral distance.

Furthermore, it is advantageous if the assistance system is configured to check a formation of an emergency lane by the at least one further road user on the basis of the lateral distance. It can be checked on the basis of the lateral distance of the at least one further road user to the respective roadway markings or roadway boundaries of the adjacent lane whether the further road user forms an emergency lane themself. If it is recognized that the further road user likewise forms an emergency lane, the emergency lane can be formed by the ego vehicle itself and/or a small lateral distance to the adjacent lane can be selected. In this case, it can be presumed that the driver recognizes that the further road users likewise form the emergency lane and that the driver is therefore not unsettled upon the automated maneuvering of the vehicle at the lane edge. However, if the further road user is located relatively close to the lane edge, it can be presumed that they do not themselves form the emergency lane. In this case, the formation of the emergency lane may not take place and/or a smaller lateral distance to this lane edge may be set.

In a further embodiment, the assistance system is configured to determine a lateral offset from at least one further one of the road users on the lane on which the vehicle is located to the determined lane edge on the basis of the surroundings data and to additionally carry out the automated lateral control depending on the lateral offset. In other words, the further road users can also be monitored who are located on the lane of the ego vehicle. The further road users can preferably be located here in front of the vehicle in the direction of travel. It can also be provided that the further road users behind the ego vehicle are taken into account. If these further road users on the ego lane form an emergency lane, an emergency lane can also be formed using the ego vehicle.

The assistance system can furthermore be configured to classify the further road users on the adjacent lane and to carry out the automated lateral control to form the emergency lane depending on the classification. If the further road user is classified as a truck, for example, the formation of the emergency lane may not take place. It can also be provided that if the further road user is classified as a truck, a higher lateral offset is selected in the formation of the emergency lane than upon the classification of the road user as a passenger vehicle. It can be taken into account here that the driver can feel more unsafe when forming the emergency lane with a truck on the adjacent lane than with a passenger vehicle.

Furthermore, it is advantageous if the assistance system is configured to carry out the automated lateral control during hands-off operation of the vehicle. During the hands-off operation, the assistance system intervenes in the steering in order to keep the vehicle in the current lane. In this case, it is made possible for the driver of the vehicle to take their hands off the steering wheel. Furthermore, the attentiveness of the driver is monitored by means of a corresponding driver monitoring unit or an interior camera. It can be checked by means of this driver monitoring unit whether the driver directs their attention to the roadway or the traffic events on the roadway. For this purpose, the viewing direction, the pupil position, a head turn, an alignment of the torso, or the like can be evaluated. In hands-off operation, there is the risk that the driver, if they feel uncomfortable and/or unsafe, puts their hands back on the steering wheel although the assistance system would permit permanent hands-off operation even in the case of congestion travel with emergency lane.

A vehicle according to the invention comprises an assistance system according to the invention. The vehicle is designed as a passenger vehicle.

A method according to the invention is used to support a driver of a vehicle when forming an emergency lane. The method comprises receiving surroundings data, wherein the surroundings data describe lanes of a roadway and wherein the surroundings data describe a position and a speed of further road users on the roadway. In addition, the method comprises determining whether a predetermined emergency lane situation exists, in which an emergency lane is to be formed by the vehicle. In addition, the method comprises determining a lane edge to which the vehicle is to be moved to form the emergency lane and carrying out automated lateral control of the vehicle to the determined lane edge if the predetermined emergency lane situation exists. In addition, the method comprises determining a differential speed between the vehicle and at least one of the further road users on an adjacent lane on the basis of the surroundings data. Moreover, the method comprises determining a lateral distance of the at least one further road user to a roadway marking of the adjacent lane on the basis of the surroundings data. In addition, the method comprises carrying out the automated lateral control depending on the differential speed and/or the lateral distance.

A further aspect of the invention relates to a computer program comprising commands which, when the program is executed by a computing unit of the assistance system, cause it to carry out a method according to the invention and the advantageous designs thereof. Furthermore, the invention relates to a computer-readable storage medium comprising commands which, when executed by the computing unit of the assistance system, cause it to carry out a method according to the invention and the advantageous designs thereof.

The preferred embodiments presented with respect to the assistance system according to the invention and the advantages thereof apply accordingly for the vehicle according to the invention, the method according to the invention, the computer program according to the invention, and the computer-readable storage medium according to the invention.

Further features of the invention result from the claims, the figures, and the description of the figures. The features and combinations of features mentioned above in the description, and the features and combinations of features mentioned hereinafter in the description of the figures and/or solely shown in the figures are usable not only in the respectively specified combination, but also in other combinations or alone, without departing from the scope of the invention.

The invention will now be explained in more detail on the basis of preferred exemplary embodiments and with reference to the appended drawings. In the figures:

### BRIEF DESCRIPTION OF THE DRAWINGS

FIG. 1 shows a schematic representation of a vehicle which has an assistance system for supporting a driver of the vehicle when forming an emergency lane;

FIG. 2 shows the vehicle from FIG. 1 on a roadway which comprises four lanes in a first traffic situation; and

FIG. 3 shows the vehicle according to FIG. 1 on a roadway which comprises four lanes according to a further traffic situation.

### DETAILED DESCRIPTION OF THE DRAWINGS

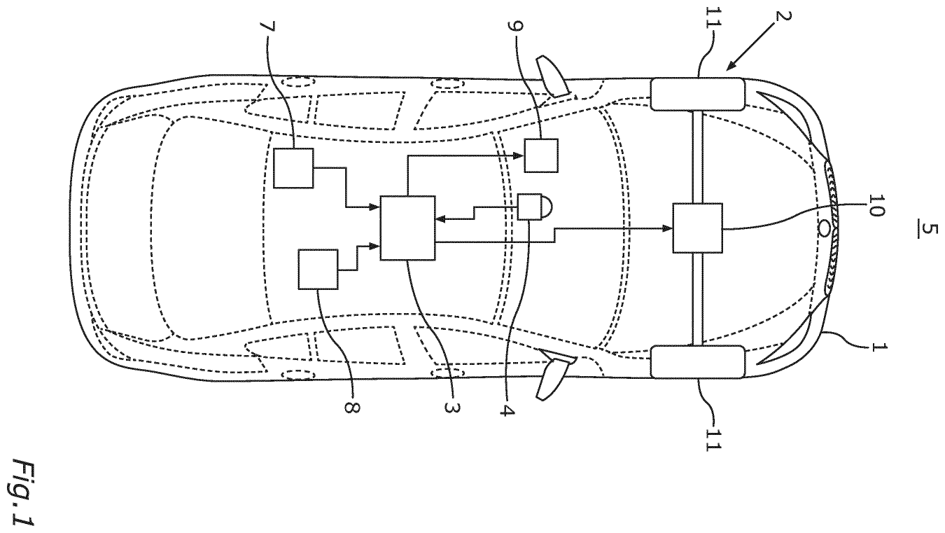

FIG. 1 shows a vehicle 1, which is designed in the present case as a passenger vehicle, in a top view. The vehicle 1 comprises an assistance system 2, which is configured to support a user or driver of the vehicle 1 in a lateral control of the vehicle 1. In particular, the assistance system 2 is used to take over automated lateral control of the vehicle 1. The assistance system 2 can preferably support the driver in the lateral control of the vehicle 1 such that the driver can permanently take their hands off the steering wheel.

The assistance system 2 comprises a computing unit 3, which can be formed, for example, by at least one electronic control unit of the vehicle 1. In addition, the assistance system 2 comprises at least one surroundings sensor 4, which is designed in the present case as a camera. Using this surroundings sensor 4, surroundings data or image data can be provided, which describe the surroundings 5 of the vehicle 1. In particular, the surroundings data or image data can describe boundaries of lanes 13, 14, 15, 16, in particular roadway markings 6 of a roadway 12. The surroundings data can be transmitted from the surroundings sensor 4 or the camera to the computing unit 3. Moreover, it can be provided that the assistance system 2 has further surroundings sensors, such as radar sensors, lidar sensors, or the like.

Furthermore, the assistance system 2 comprises a receiver 7 for a satellite-based position determination system. Satellite-based position data, which describe the position of the vehicle 1, can be received by means of the receiver 7. In addition, the assistance system 2 comprises a storage unit 8, on which high-resolution map data or so-called HD maps are stored. In addition, the assistance system 2 comprises an output unit 9, by means of which an output can be output to the driver of the vehicle 1. This output can in principle be output optically, acoustically, and/or haptically.

In addition, the computing unit 3 is configured to actuate a steering system 10 (only shown schematically in the present case) of the vehicle 1. The driver of the vehicle 1 can be supported in the lateral control by the actuation of the steering system 10. Steerable wheels 11 of the vehicle 1 can be moved here by the actuation of the steering system 10. It is preferably moreover provided that a drive motor and/or a braking system of the vehicle 1 can also be actuated by means of the computing unit 3 in order to also intervene in a longitudinal control of the vehicle 1.

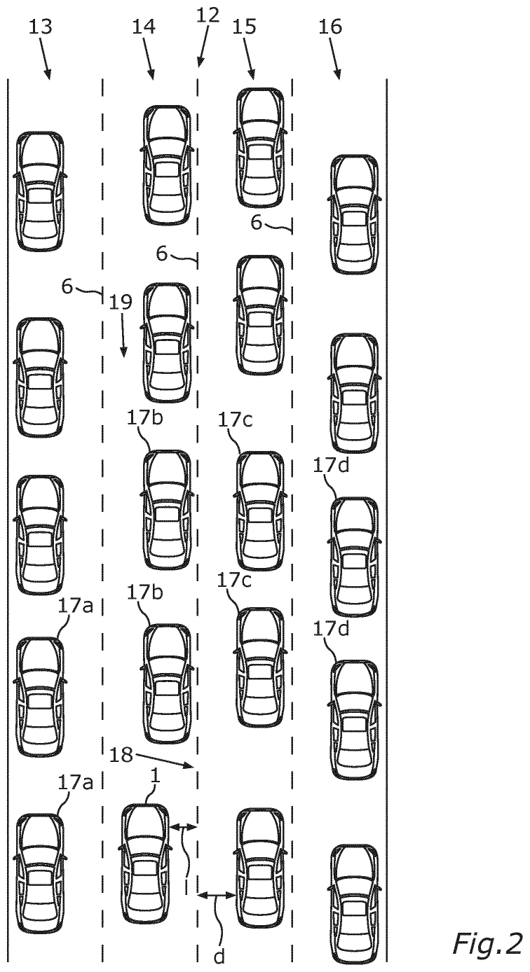

FIG. 2 shows the vehicle 1 on a multilane roadway 12. The roadway 12 can be designed, for example, as a freeway. In the present example, the roadway 12 comprises four lanes 13, 14, 15, 16, which are separated from one another by roadway markings 6. In the present case, the ego vehicle 1 is located on the second lane 14 from the left.

On the basis of the surroundings data, the assistance system 2 can detect further road users 17a, 17b, 17c, and 17d. In particular, the assistance system 2 or the computing unit 3 can determine the respective positions of the further road users 17a to 17d in relation to the respective lanes 13 to 16. Moreover, a differential speed or relative speed between the vehicle 1 and the further road users 17a to 17d can be ascertained by means of the computing unit 3 on the basis of the surroundings data. In addition, a lateral distance d of the respective road users 17a to 17d to the respective roadway markings 6 can be ascertained on the basis of the surroundings data by means of the computing unit 3 or by means of the assistance system 2.

In addition, it can be checked by means of the computing unit 3 whether a predetermined emergency lane situation exists. Such an emergency lane situation exists, for example, if the speed of the vehicle 1 falls below a predetermined speed limiting value. Moreover, the emergency lane situation exists if the vehicle 1 is located on a roadway 12 or road of a predetermined road type. Such a road type can be, for example, a freeway, a main road, or the like.

In addition, the assistance system 2 or the computing unit 3 is configured, upon the presence of the emergency lane situation, to ascertain the lane 13 to 16 on which the vehicle 1 is currently located. Depending on the lane 13 to 16 on which the vehicle is currently located, a lane edge 18 can then be determined to which the vehicle is to be moved to form the emergency lane. In this case, the country-specific rules for forming the emergency lane 19 are taken into account. In the example according to FIG. 2, it is presumed that the vehicle 1 travels in Germany, for example. In the example shown, the vehicle 1 is located on the second lane 14 from the left. To form an emergency lane, the vehicle 1 is to be moved to the right lane edge 18 of the lane 14.

In the present case, it is provided that the assistance system 2 is configured to intervene in the steering system 10 to form the emergency lane 19 and to maneuver the vehicle 1 in an automated manner to the determined lane edge 18. The intervention in the steering system 10 to form the emergency lane 19 takes place here depending on the differential speeds of the vehicle 1 to the further road users 17a to 17d. In particular, the lateral control of the vehicle 1 is carried out depending on the differential speeds to the further road users 17c, who are located on the lane 15 adjacent to the lane edge 18.

Alternatively or additionally, the intervention in the steering system 10 to form the emergency lane 19 takes place depending on the respective lateral distances d of the road users 17a to 17d to the respective roadway markings 6. In particular, the emergency lane 19 is formed depending on the lateral distance d of the further road users 17c to the respective roadway markings 6. In this case, in particular the further road users 17c on the lane 15 adjacent to the lane edge 18 are observed. It can be checked on the basis of the respective distances d of the further road users 17c whether these further road users 17c likewise form an emergency lane. In the traffic situation according to FIG. 2, the further road users 17c on the adjacent lane 15 each form an emergency lane.

It can be decided depending on the differential speed and/or the lateral distance d whether the emergency lane 19 is formed or not using the ego vehicle 1. Moreover, it can be provided that a lateral offset I of the vehicle 1 to the lane edge 18 is determined depending on the differential speed and/or the lateral distance d.

In a first example, it is presumed that the ego vehicle 1 moves at a speed of 30 km/h. Moreover, it is presumed that the further road users 17c on the further lane move at a speed of an average of 25 km/h. In the present case, the differential speed between the ego vehicle 1 and the further road users 17c on the adjacent lane 15 is low. In addition, the further road users 17c on the lane 15 form an emergency lane. It is therefore provided in this first example that the ego vehicle also forms an emergency lane and is therefore maneuvered to the right lane edge 18.

In the traffic situation according to FIG. 2 it is now presumed in a second example thereof that the ego vehicle 1 moves at a speed of 50 km/h and the further road users 17c on the lane 15 move on average at a speed of 20 km/h. The differential speed to the adjacent lane is here in the moderate range and the further road users 17c likewise form the emergency lane. It is therefore also provided in this second example that the vehicle 1 is maneuvered in the direction of the right lane edge 18. In this case, the lateral offset I to the right lane edge is determined such that the emergency lane 19 is partially formed.

In the traffic situation according to FIG. 2, it is presumed in a third example that the ego vehicle moves at a speed of 50 km/h and the further road users 17c on the lane 15 move at an average speed of 5 km/h. The differential speed between the ego vehicle 1 and the further road users 17c is high here. In this case, an emergency lane 19 is therefore not formed by the vehicle 1, even if the further road users 17c themselves form an emergency lane. At this high differential speed, a driving feeling subjectively perceived as uncomfortable and/or unsafe can result for the driver. In hands-off operation it can have the result that the driver tends to put their hands back on the steering wheel.

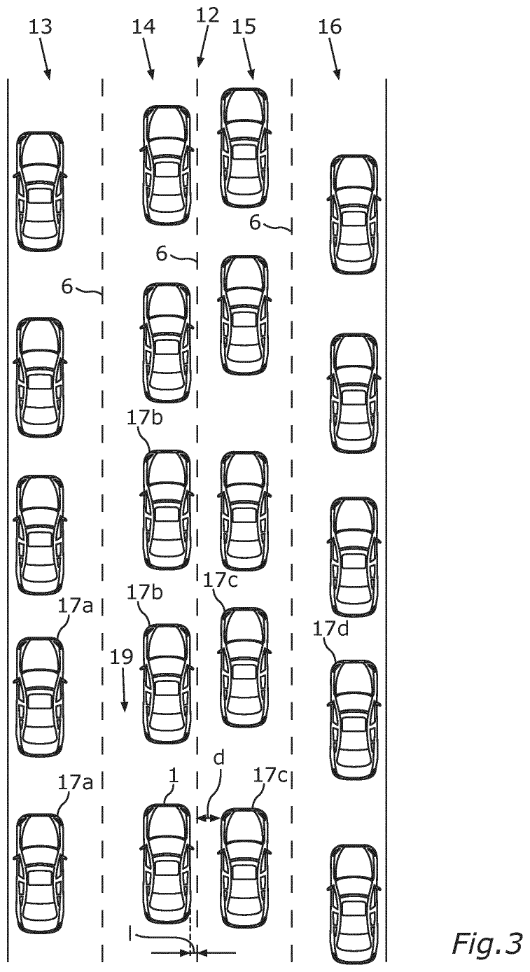

FIG. 3 shows the vehicle 1 in a further traffic situation on the four-lane roadway 12. An emergency lane situation also exists here, wherein the further road users 17c on the adjacent lane 15 do not form an emergency lane. If it is presumed, for example, that the ego vehicle 1 moves at a speed of 10 km/h and the further road users 17c move at a speed of 5 km/h on average, in this case the emergency lane 19 is formed because the differential speed between the vehicle 1 and the further road users 17c is sufficiently low.

1-9. (canceled)

10. An assistance system for supporting a driver of a vehicle when forming an emergency lane, wherein the assistance system is configured to:
receive surroundings data, wherein the surroundings data describe lanes of a roadway and describe a position and a speed of further road users on the roadway;
determine whether a predetermined emergency lane situation exists, in which the emergency lane is to be formed by the vehicle;
determine a lane edge, to which the vehicle is to be moved to form the emergency lane; and
carry out an automated lateral control of the vehicle to the lane edge if the predetermined emergency lane situation exists;
determine a differential speed between the vehicle and at least one of the further road users on an adjacent lane based on the surroundings data;
determine a lateral distance of the at least one of the further road users to a roadway marking of the adjacent lane based on the surroundings data; and
carry out the automated lateral control depending on the differential speed or the lateral distance.

11. The assistance system according to claim 10, wherein the at least one of the further road users is located on the adjacent lane which is adjacent to the lane edge to which the vehicle is to be moved to form the emergency lane.

12. The assistance system according to claim 10, wherein the assistance system prevents the automated lateral control to the lane edge if the differential speed exceeds a predetermined differential speed limiting value or if the lateral distance falls below a predetermined distance limiting value.

13. The assistance system according to claim 11, wherein the assistance system prevents the automated lateral control to the lane edge if the differential speed exceeds a predetermined differential speed limiting value or if the lateral distance falls below a predetermined distance limiting value.

14. The assistance system according to claim 10, wherein the assistance system is configured to carry out the lateral control such that a lateral offset of the vehicle to the lane edge is determined depending on the differential speed or the lateral distance.

15. The assistance system according to claim 11, wherein the assistance system is configured to carry out the lateral control such that a lateral offset of the vehicle to the lane edge is determined depending on the differential speed or the lateral distance.

16. The assistance system according to claim 12, wherein the assistance system is configured to carry out the lateral control such that a lateral offset of the vehicle to the lane edge is determined depending on the differential speed or the lateral distance.

17. The assistance system according to claim 10, wherein the assistance system is configured to check a formation of an emergency lane by the at least one of the further road users based on the lateral distance.

18. The assistance system according to claim 11, wherein the assistance system is configured to check a formation of an emergency lane by the at least one of the further road users based on the lateral distance.

19. The assistance system according to claim 12, wherein the assistance system is configured to check a formation of an emergency lane by the at least one of the further road users based on the lateral distance.

20. The assistance system according to claim 10, wherein the assistance system is configured to determine a lateral offset of at least one further one of the road users on a lane on which the vehicle is located to the determined lane edge based on the surroundings data and to additionally carry out the automated lateral control depending on the lateral offset.

21. The assistance system according to claim 11, wherein the assistance system is configured to determine a lateral offset of at least one further one of the road users on a lane on which the vehicle is located to the determined lane edge based on the surroundings data and to additionally carry out the automated lateral control depending on the lateral offset.

22. The assistance system according to claim 12, wherein the assistance system is configured to determine a lateral offset of at least one further one of the road users on a lane on which the vehicle is located to the determined lane edge based on the surroundings data and to additionally carry out the automated lateral control depending on the lateral offset.

23. The assistance system according to claim 10, wherein the assistance system is configured to carry out the automated lateral control during hands-off operation of the vehicle.

24. The assistance system according to claim 11, wherein the assistance system is configured to carry out the automated lateral control during hands-off operation of the vehicle.

25. The assistance system according to claim 12, wherein the assistance system is configured to carry out the automated lateral control during hands-off operation of the vehicle.

26. A passenger vehicle comprising an assistance system according to claim 10.

27. A method for supporting a driver of a vehicle when forming an emergency lane, the method comprising:
receiving surroundings data, wherein the surroundings data describe lanes of a roadway and describe a position and a speed of further road users on the roadway;
determining whether a predetermined emergency lane situation exists, in which the emergency lane is to be formed by the vehicle;
determining a lane edge, to which the vehicle is to be moved to form the emergency lane;
carrying out an automated lateral control of the vehicle to the lane edge if the predetermined emergency lane situation exists,
determining a differential speed between the vehicle and at least one of the further road users on an adjacent lane based on the surroundings data;
determining a lateral distance of the at least one of the further road users to a roadway marking of the adjacent lane based on the surroundings data; and
carrying out the automated lateral control depending on the differential speed or the lateral distance.
